(19) United States
(12) Patent Application Publication
(10) Pub. No.: US 2011/0304324 A1
(43) Pub. Date: Dec. 15, 2011

(54) MAGNETIC ENCODER

(75) Inventor: Heinrich Acker, Schwalbach (DE)

(73) Assignee: Continental Teves AG & Co. oHG, Frankfurt (DE)

(21) Appl. No.: 13/131,644

(22) PCT Filed: Dec. 1, 2009
(86) PCT No.: PCT/EP2009/066137

§ 371 Date: Sep. 6, 2011

(30) Foreign Application Priority Data
Dec. 1, 2008 (DE) 10 2008 059 774.0

(51) Int. Cl. G01B 7/30; G11B 5/127

(52) U.S. Cl. 324/207.25; 29/603.01

(57) ABSTRACT

A magnetic encoder having at least one encoder track including one or more pole pairs, wherein the magnetization directions of subregions within at least one of the poles are embodied so as to change substantially continuously and/or monotonically along the encoder track.

### CROSS REFERENCE TO RELATED APPLICATIONS

This application is the U.S. National Phase Application of PCT International Application No. PCT/EP2009/066137, filed Dec. 1, 2009, which claims priority to German Patent Application No. 10 2008 059 774.0, filed Dec. 1, 2008, the contents of such applications being incorporated by reference herein.

### FIELD OF THE INVENTION

The invention relates to a magnetic encoder, a method for producing a magnetic encoder and the use of the magnetic encoder in motor vehicle sensor arrangements.

### BACKGROUND OF THE INVENTION

Magnetic encoders which are used in sensor arrangements for directly or indirectly measuring variables, for example rotational angle, length or speed, are known. These magnetic encoders are normally permanently magnetic or hard-magnetic and have an encoder track with a plurality of pole pairs, with the magnetic field of these poles being detected by one or more magnetic field sensor elements.

The information which the encoder supplies via the measurement variable can generally be encoded in the field direction and/or in the field strength. Evaluation of the field direction has the advantage that the field direction is largely independent of temperature, whereas all permanent magnets exhibit temperature-dependent field strength. The magnetic field sensor elements also operate as a function of temperature.

With regard to the measurement tasks, a distinction has to be drawn between switching applications (change in state when crossing a threshold of the measurement variable) and measurements in the narrower sense. The magnetic encoders proposed and discussed here are preferably provided in respect of the use for such measurements in the narrower sense which can be generally characterized in that a uniform sensitivity, resolution and accuracy is required over the measurement range when determining the measurement variable.

The above requirement for uniform design and effect in conjunction with the measurement of the field direction shows that the field direction should change in as linear a manner as possible with the measurement variable. Any deviation from this causes an error or at least expenditure on correction in the measurement system. The usual design of encoders in terms of their calculation and magnetization relates to encoders with poles in the form of blocks, with each pole corresponding to a zone with substantially homogeneous magnetization with regard to direction and intensity. Such customary magnetic encoders of this kind are illustrated with reference to FIGS. 1 and 2.

One disadvantage of this block-like magnetization is the high cross sensitivity in terms of the reading distance or the normal distance of the magnetic field sensor element from the encoder track or the encoder surface. The function measurement variable=f(field direction) is influenced by this such that, when there is a small distance in relation to the pole length, the magnetic field exhibits changes in the magnetization direction only in the vicinity of the boundaries between the poles. However, when there is a large distance, somewhat uniform rotation over the value range of the measurement variable or along the encoder track, as is required by measurement, is obtained due to superimposition of the field of a plurality of poles.

In order to design sensor arrangements for field direction measurements with the known encoders which are magnetized in a block-like manner, the following requirements or rules of thumb have to be satisfied: the reading distance or the air gap between encoder surface or encoder track and magnetic field sensor element should correspond at least to half the pole length of the encoder. The material thickness of the encoder should likewise be at least half the pole length.

However, these requirements conflict with the following restrictions: each encoder generates the maximum field strength directly at its surface. The field direction is also characterized most precisely by the encoder there because external interfering fields take up a lower proportion of the total field—however, at a distance of half the pole length, the field strength is already considerably lower and therefore the susceptibility to faults is higher.

At a relatively large reading distance, for example the abovementioned air gap of at least half a pole length, some of the encoder material is used solely to generate a sufficiently strong field, so that the magnetic field sensor element can still detect the magnetic field of the poles.

Encoders with a high material thickness, for example with a thickness of at least half a pole length, can be completely magnetized only with relative difficulty.

The greater the requirements made of the sensor arrangement, the greater the conflict in terms of objective with regard to the reading distance: a greater distance means an increase in linearity but a loss in field strength and therefore a worsening of the signal-to-noise ratio or signal-to-interference ratio at the magnetic field sensor element.

### SUMMARY OF THE INVENTION

The invention is based on the object of proposing a magnetic encoder which at least partially eliminates or at least reduces the above requirements and/or restrictions.

The invention is preferably based on the idea of proposing a magnetic encoder having at least one encoder track which comprises one or more pole pairs, with at least one pole having at least one magnetization which comprises magnetization directions which change substantially monotonically and/or continuously along the encoder track. In this case, these magnetization directions are, in particular, associated with adjacent subregions of the pole along the encoder track.

As a result, there is already a substantially linear relationship between field angle or detectable magnetic field and measurement variable or relative position between the encoder and a magnetic field sensor element at the surface of the encoder. For this reason, the reading distance or air gap between the encoder and magnetic field sensor element can be kept relatively low, that is to say considerably smaller than half the pole length, when the magnetic encoder according to aspects of the invention is used in a sensor arrangement for field angle/field direction detection. In addition, only a relatively low material thickness of the encoder is therefore required, this permitting a reduction in cost, and the resistance to interference or the signal-to-noise ratio of the sensor arrangement is likewise improved by the short air gap length which can now be applied.

The encoder track preferably runs along a measurement direction or a magnetically impressed scale of the encoder and/or is expediently composed of the successive poles.

The magnetic encoder is preferably in the form of a permanent magnet composed of hard-magnetic material.

The magnetization direction preferably relates to the profile direction of the encoder track, that is to say the magnetization direction is, in particular, always related to a tangent with respect to the encoder track, which tangent is positioned in the respective subregion.

The poles of the magnetic encoder are preferably not magnetized in a block-like manner and/or homogeneously.

The magnetization directions of the subregions within two successive pole lengths along the encoder track are preferably embodied such that these magnetization directions substantially map a rotation through 360°.

The respective changes in the magnetization directions, in particular all the magnetization directions, of adjacent subregions of one or more or all the poles along the encoder track are preferably embodied so as to run substantially continuously.

It is preferred that the respective change in the magnetization directions of adjacent subregions of one or more or all the poles along the encoder track is embodied substantially linear to the corresponding change in length of travel along the encoder track.

A subregion is preferably understood to be a region of the one pole or of the plurality of poles or of all the poles which is infinitesimally narrow, in particular strip-shaped, along the encoder track.

It is preferred that, at least within the subregions in a central segment of a pole which comprises 50% of the pole length along the encoder track and is bounded by two edge segments of this pole comprising in each case 25% of the pole length on both sides, the magnetization directions of these subregions in the central segment of this pole substantially map a rotation of at least 45°, in particular at least 70°, particularly preferably 90°±5°, and/or that the magnetization directions of the two subregions of the central segment of this pole which are outermost on either side are embodied such that they are rotated through at least 45°, in particular at least 70°, particularly preferably 90°±5°, in relation to one another or with respect to one another, with the magnetization directions always being based on the respective profile direction of the encoder track. The magnetization directions of these subregions in the central segment of this pole very particularly preferably map a rotation of substantially 90°.

The encoder track is expediently curved, in particular annular, or alternatively preferably substantially straight.

The encoder track and/or the encoder are/is preferably formed substantially in accordance with one of the following geometric shapes: ring, ring segment, flat cylinder, cuboid, rectangular solid, flat, disk-shaped right parallelepiped, cylinder, long cylinder or half-cylinder, divided along the longitudinal axis.

It is preferred that the method is developed by the raw encoder being moved past the field-generating means in a mechanically guided manner with a rotational movement along the magnetization path, and the field-generating means being moved so as to rotate about its own axis with superimposition to this end.

The magnetization path is expediently understood to be a path along the encoder track which is to be magnetized.

The field-generating means is preferably in the form of a permanent magnet or alternatively preferably a coil or coil arrangement, in particular a superconductive coil or coil arrangement.

The raw encoder is preferably at least partially formed from ferrite.

The method for producing a magnetic encoder is expediently carried out by means of a magnetization apparatus which has two drives or drive means, one of which induces and allows the movement of the raw encoder or of the field-generating means along the magnetization path, and the other of which induces and allows the rotational movement of the field-generating means about its own axis. In this case, the drives are, in particular, in the form of stepper motors. In this case, the magnetization apparatus is expediently designed for manufacturing prototypes, as a result of which in each case no specific tool or only a tool which is designed for magnetizing a specific encoder has to be used for magnetizing different encoders, for example raw encoders of different design and/or different magnetization patterns.

It is expedient for the field-generating means to be suspended in a rotatable manner with respect to an axis and, in this respect, to be able to be rotated such that the field direction changes. The unmagnetized encoder or raw encoder is mounted in a holder, in which it can be moved in a rotational or translatory manner in the same direction as in a finished sensor arrangement, with respect to the direction of the pole change and the measurement variable. The raw encoder and the field-generating means are now moved such that an angle of the field-generating means belongs to each value of the measurement variable, exactly as in the finished sensor arrangement. If the field-generating means is located in the immediate vicinity of the encoder surface in this case, the encoder is magnetized in the required way.

The invention also relates to the use of the magnetic encoder in motor vehicle sensor arrangements, in particular in rotational angle sensor arrangements.

The magnetic encoder is preferably intended to be used in sensor arrangements which are used as travel and/or position and/or angle and/or speed sensor arrangements in the motor vehicle industry, in automation engineering or in robotics. In particular, said magnetic encoder is intended to be used in steering angle sensor arrangements in motor vehicles.

### BRIEF DESCRIPTION OF THE DRAWINGS

The invention is best understood from the following detailed description when read in connection with the accompanying drawings. Included in the drawings is the following figures:

FIG. 1 shows an exemplary, annular, magnetic encoder according to the prior art,

FIG. 2 shows an exemplary embodiment of a conventional bar-like encoder,

FIG. 3 shows an exemplary annular encoder with magnetization directions which rotate continuously along the encoder track,

FIG. 4 shows an exemplary embodiment of a bar-like, straight encoder with magnetization directions which rotate continuously along the encoder track,

FIG. 5 shows an exemplary graphical representation of the magnetization direction as a function of the standardized length of travel along the encoder track in relation to an encoder with block-like magnetization and in relation to an encoder with magnetization directions which rotate continuously along the encoder track, and

FIG. 6 shows an exemplary magnetization apparatus.

### DETAILED DESCRIPTION OF THE PREFERRED EMBODIMENTS

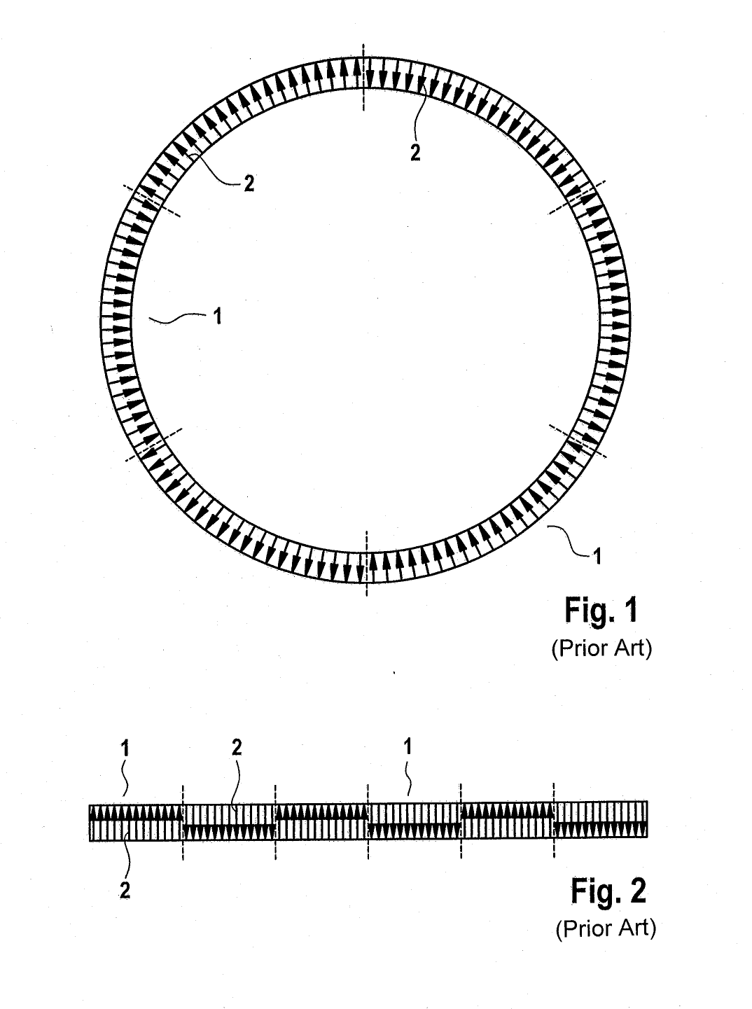

FIG. 1 shows an annular encoder with six poles and FIG. 2 shows a linear or straight encoder with six poles, both encoders being formed in a conventional manner. The magnetization directions 2 of individual subregions of the poles 1 are represented by arrows. The poles 1 are magnetized in a homogeneous or block-like manner. The encoders therefore have an alternating north/south magnetization. The arrangement of the poles in series forms, for example, the encoder track.

A magnetic field sensor element (not illustrated) detects, in the close range or when the air gap is relatively small, the block-like or box-profile-like magnetizations of the poles over their homogeneous magnetic field. Only when there is a relatively large air gap can the magnetic field sensor arrangement carry out an angular measurement in which the detected angle of the magnetic field rotates with any kind of uniformity along the encoder track, since, when there is a relatively large distance from the encoder track, the magnetic fields of the adjacent and surrounding poles are superimposed on one another. However, a relatively strong magnetic field of the encoder is necessary to this end.

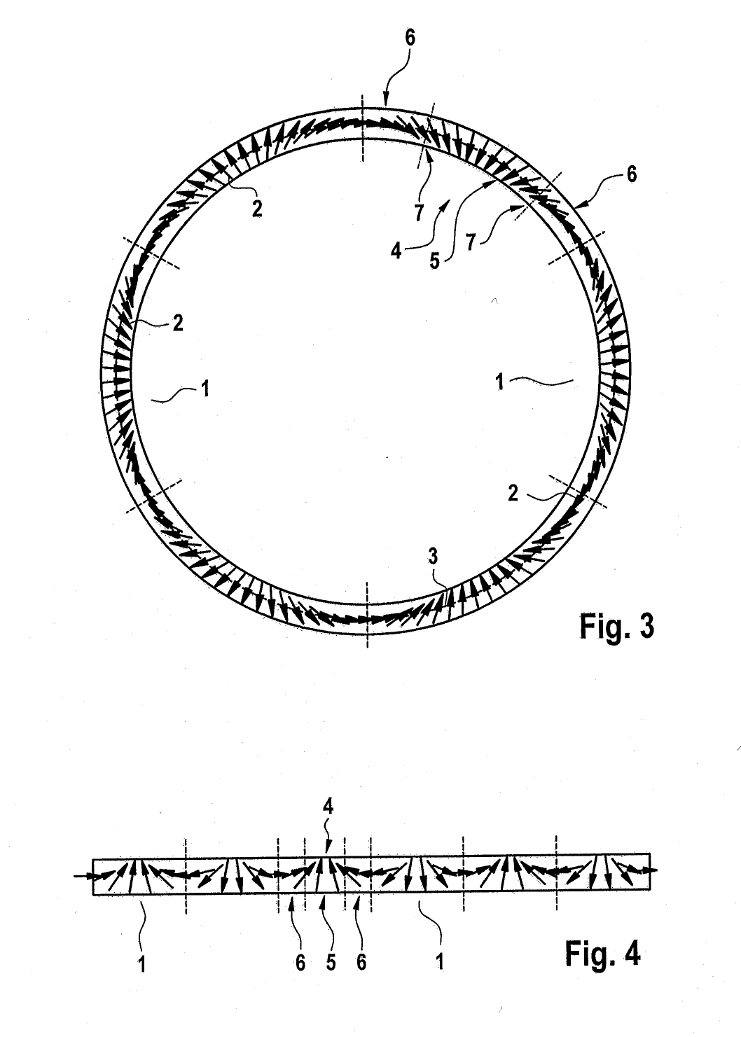

FIG. 3 illustrates an exemplary, annular encoder with magnetization directions 2 which rotate continuously along the encoder track and are illustrated in an individual or exemplary fashion as arrows. In this case, the encoder track runs, for example, along the dashed center line 3 of the ring and is formed by the arrangement of the poles 1 in series. The encoder and the poles 1 are magnetized in such a way that the respective changes in the magnetization directions 2 of adjacent subregions of the poles 1 along the encoder track are embodied so as to run linearly and continuously with respect to the length of travel along the encoder track or with respect to the length of travel along the dashed center line 3. Therefore, even when there is a relatively small air gap and independently of the air gap length, a magnetic field sensor element (not illustrated) can detect a magnetic field which is embodied in a uniformly rotating manner along the encoder track, as a result of which radial angular measurement is possible substantially independently of the air gap length.

By way of example, the magnetization of the poles 1 is explained in more detail on the basis of the pole 4. The pole 4 can be divided into a central segment 5 with 50% of the pole length and two edge segments 6 which bound this central segment 5 and in each case form 25% of the pole length. Within this central segment 5, the magnetization directions 2 of the subregions map a rotation of substantially 90°, this being implemented in a real encoder, for example, as a rotation of 90°±5° due to manufacturing inaccuracies. In other words, the magnetization directions 2 of the two subregions 7 of the central segment 5 of this pole 4 which are outermost on either side are embodied as being rotated through substantially 90° or 90°±5° in relation to one another.

The subregions are, for example, actually infinitesimally narrow along the encoder track, but this cannot be tangibly represented.

FIG. 4 shows an exemplary embodiment of a straight encoder with a magnetization as explained in FIG. 3. Said straight encoder likewise has corresponding poles 1 and magnetization directions 2 of subregions, it being possible to see the rotating profile thereof along the encoder track in detail with reference to an exemplary pole 4. This pole 4 can likewise be divided into a corresponding central segment 5 and two edge segments 6.

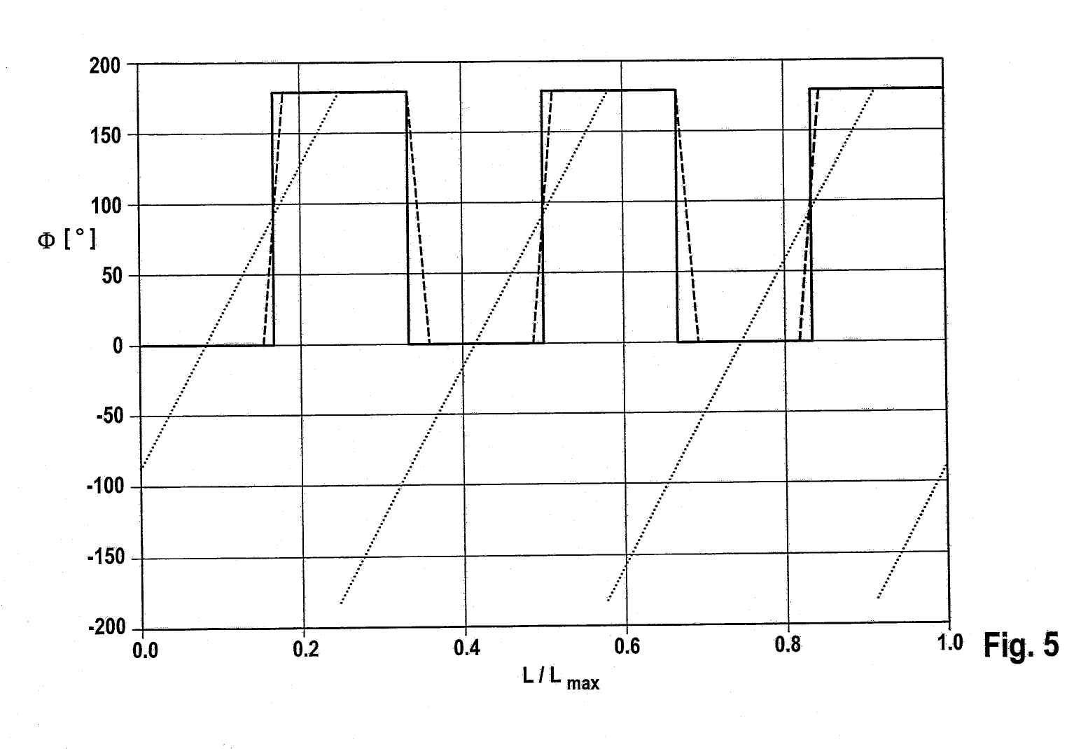

In FIG. 5, for the sake of clarification, the field direction D is plotted in degrees against the standardized encoder track length L/Lₘₐₓ, i.e. the measurement variable or the field line profile which is detected by a magnetic field sensor element along the encoder track, of a sensor arrangement (not illustrated). In this case, the continuous curve represents an encoder which is magnetized in a block-like manner according to the prior art, measured directly at the surface, with the idealization of block-like poles according to FIG. 2. The dashed curve represents the same encoder at the same distance, but taking into account a transition zone which is always present between the poles in reality. The dotted curve represents the field direction profile of an exemplary encoder according to aspects of the invention as per FIG. 4 in relation to a relatively freely selectable air gap. The dotted curve likewise represents the field curve profile, which can be detected by a magnetic field sensor element, of a conventional encoder which is magnetized in a block-like manner in an idealization and with a relatively large air gap if the rules of thumb explained further above relating to encoder design are followed.

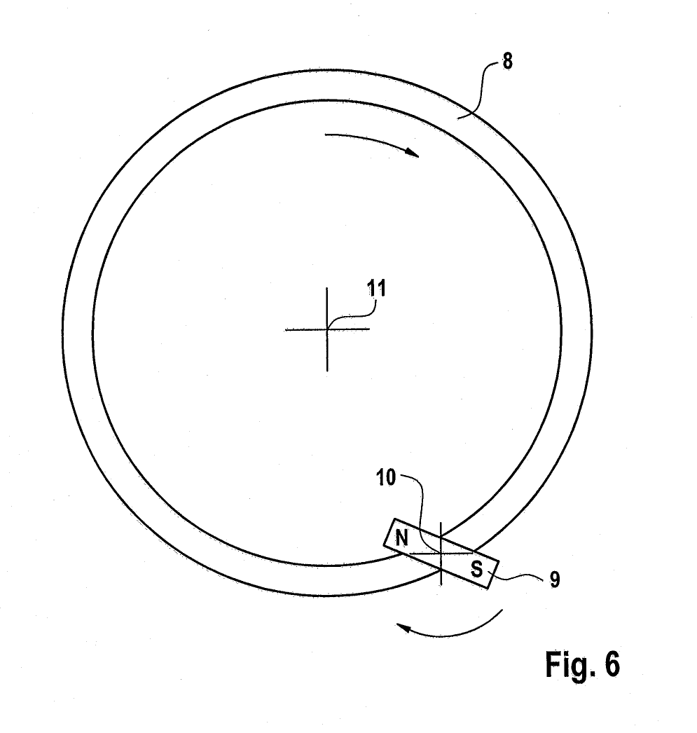

An exemplary magnetization apparatus for producing a magnetic encoder with magnetization directions which rotate continuously along the encoder track is illustrated in FIG. 6. The raw encoder 8 or the unmagnetized encoder is mounted about its center 11 in such a way that it can move in rotation in the direction of the associated arrow. The field-generating means 9, in the form of a bar-shaped permanent magnet by way of example, is mounted such that it can rotate in relation to the axis 10.

For the purpose of magnetization, the two movements are carried out in a coordinated manner with respect to one another so that each region of the raw encoder 8 reaches, during its rotation about 11, a point under field-generating means 9 at a time at which the field-generating means 9 is in the suitable angular position. After a complete revolution of the encoder, the magnetization thereof is terminated, for example, in accordance with FIG. 3. To this end, the field-generating means 9 carries out exactly three revolutions during the one 360° revolution of the encoder. By means of this method, it is possible to implement slightly different encoders with different pole numbers with the same design. Only the transmission ratio and the relative angular speed of the drives have to be changed, and this can easily be done using stepper motors, for example.

In one exemplary embodiment (not illustrated), the field-generating means is additionally arranged or mounted such that it can be displaced in relation to its axis, as a result of which the diameter of the raw encoder can be easily adjusted.

1.-10. (canceled)

11. A magnetic encoder having at least one encoder track, comprising one or more pole pairs, wherein
the magnetization directions of subregions within at least one of the poles are embodied so as to change substantially continuously, monotonically or a combination thereof along the encoder track.

12. The magnetic encoder as claimed in claim 11, wherein the magnetization directions of the subregions within two successive pole lengths along the encoder track are embodied such that these magnetization directions substantially map a rotation through 360°.

13. The magnetic encoder as claimed in claim 11, wherein the respective changes in the magnetization directions of adjacent subregions of one or more poles are embodied so as to run substantially continuously along the encoder track.

14. The magnetic encoder as claimed in claim 11, wherein the respective change in the magnetization directions of adjacent subregions of one or more poles along the encoder track is embodied substantially linear to a corresponding change in length of travel along the encoder track.

15. The magnetic encoder as claimed in claim 11, wherein the subregions of one or more poles are infinitesimally narrow along the encoder track.

16. The magnetic encoder as claimed in claim 11, wherein, at least within the subregions in a central segment of a pole which comprises 50% of the pole length along the encoder track and is bounded on both sides by two edge segments of this pole comprising in each case 25% of the pole length, the magnetization directions of these subregions in the central segment of this pole substantially map a rotation of at least 45°.

17. The magnetic encoder as claimed in claim 16, wherein the magnetization directions of the subregions in the central segment of this pole substantially map a rotation of at least 70°.

18. The magnetic encoder as claimed in claim 11, wherein, at least within the subregions in a central segment of a pole which comprises 50% of the pole length along the encoder track and is bounded on both sides by two edge segments of this pole comprising in each case 25% of the pole length, the magnetization directions of the two subregions of the central segment of this pole which are outermost on either side are embodied such that they are rotated through at least 45° in relation to one another or with respect to one another, with the magnetization directions always being based on the respective profile direction of the encoder track.

19. The magnetic encoder as claimed in claim 18, wherein the magnetization directions of the two subregions of the central segment of this pole which are outermost on either side are embodied such that they are rotated through at least 70°.

20. The magnetic encoder as claimed in claim 11, wherein the encoder track is curved, annular, or substantially straight.

21. A method for producing a magnetic encoder as claimed in claim 11, with a raw encoder which is at least partially magnetized being exposed to the magnetic field of a field-generating means, wherein the field-generating means is rotatably mounted, with the raw encoder being magnetized by the field-generating means and/or the raw encoder being moved on a defined magnetization path at a defined distance in relation to one another to generate an encoder track, and the field-generating means being rotated about itself in a defined manner in the process.

22. The method as claimed in claim 21, wherein the raw encoder is moved past the field-generating means in a mechanically guided manner with a rotational movement along the magnetization path, and the field-generating means is moved so as to rotate about its own axis with superimposition to this end.

23. The use of the magnetic encoder as claimed in claim 11 in motor vehicle sensor arrangements.

24. The use of the magnetic encoder as claimed in claim 11 in motor vehicle rotational angle sensor arrangements.
